(19) United States
(12) Patent Application Publication
(10) Pub. No.: US 2012/0057506 A1
(43) Pub. Date: Mar. 8, 2012

(54) Large network association procedure in power efficient manner

(76) Inventor: Praveen Kumar, Bangalore (IN)

(21) Appl. No.: 13/319,131

(22) PCT Filed: Feb. 11, 2010
(86) PCT No.: PCT/IN10/00079

§ 371 Date: Nov. 7, 2011

(30) Foreign Application Priority Data
May 22, 2009 (IN) 1172/CHE/2009

(51) Int. Cl. H04W 84/00; H04W 76/00; H04L 12/28

(52) U.S. Cl. 370/255

(57) ABSTRACT

The embodiments herein generally relate to distributed systems and more particularly, to association procedure in a large network. In this invention time is divided into different zones each for specific task such as to wake-up dormant devices, to synchronize unassociated devices, to transmit identity frame and then to associate with network coordinator device. In each time zone plurality of nodes perform the specific task simultaneously. This improves the power efficiency and speeds up the association procedure. This technique also improves neighboring table information, which enables better localization.

### FIELD OF THE INVENTION

The embodiments herein generally relate to large network formation and its working, more particularly, the association procedure in large distributed systems.

### CROSS REFERENCE TO RELATED APPLICATIONS

This specification is the complete specification of the provisional application No. 1172/CHE/2009 filed on 22^{nd} May, 2009 which it claims to be its priority date.

### BACKGROUND OF THE INVENTION

Any distributed system to work in synergy, it needs to form a network. In this document we will be discussing the association procedure to form a large network in the power efficient manner.

As discussed in our patent 162/CHE/2009, the devices are in dormant state before it joins the network. Dormant state means that the device listens to a preconfigured channel periodically in bursts, if it receives wake-up frame in that then it starts the association procedure otherwise continue its dormant state. Existing association procedure has two issues: i) it does not take care of orientation of nodes, i.e. the localization and association procedures are not linked which can lead to leave blank (hole) spots in the region; ii) it takes long period to form the network fully if the network size is big.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary wireless sensor network (WSN).

FIG. 2 illustrates an exemplary wake-up frame sequence.

FIG. 3 illustrates the time domain of coordinator node or personal area network coordinator (PC) illustrating the position of wake-up frame sequence.

FIG. 4 illustrates an exemplary identity frame.

FIG. 5 illustrates an exemplary time domain of personal area network coordinator (PC).

FIG. 6 illustrates an exemplary time domain of higher layer coordinators.

FIG. 7 illustrates an exemplary format of association request command.

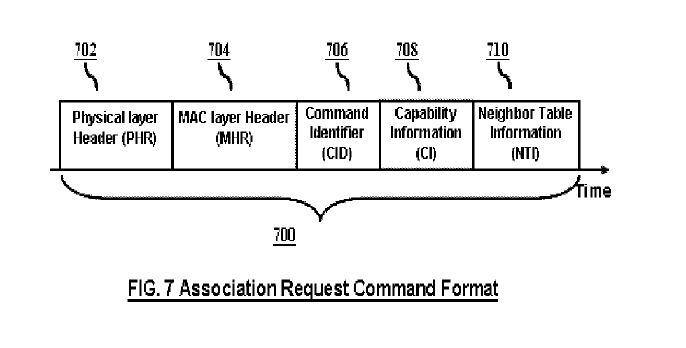

### DESCRIPTION OF THE EMBODIMENTS

Various embodiments of the present invention provide a method for the devices to associate with the network in minimum time and power efficient manner. As an example the present invention has been illustrated in the context of a wireless Sensor Network (WSN). However, it will be apparent to those ordinarily skilled in the art the applicability of the invention to many other distributed systems.

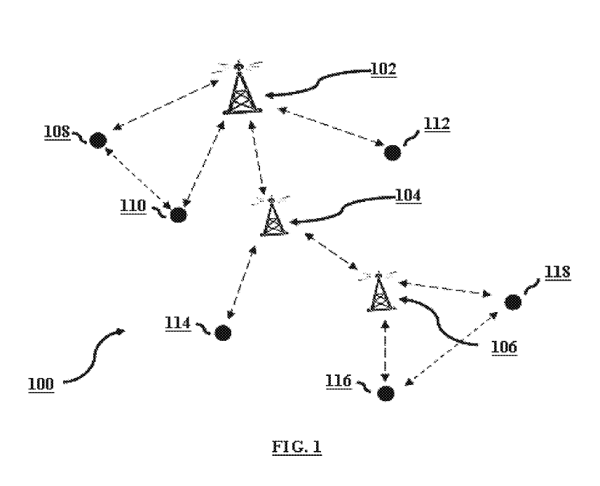

FIG. 1 illustrates exemplary wireless ad-hoc communication network (WCN) architecture 100, in accordance with various embodiments of the present invention. The WCN 100 includes a personal area network coordinator (PC) 102, network coordinators (NC) 104, 106 at different depth from the PC and end device (ED) 108, 110, 112, 114, 116 and 118 at different depth from the PC. For one embodiment, the PC 102 coordinates exchange of data between the EDs 108, 110 and 112 or between the EDs within the personal operating space. Further, the EDs 108, 110, 112, 114, 116 and 118 may be equipped with transducers, sensors and transceivers for obtaining data from a source and exchanging data with other EDs, NC and PC in the network. On obtaining the data, the corresponding ED transmits the necessary data to other EDs and/or the NC or PC. The PC, NC and ED also include a power source for driving the various electronic circuitries used in the PC, NC and the EDs. The power source can be, for example, a battery.

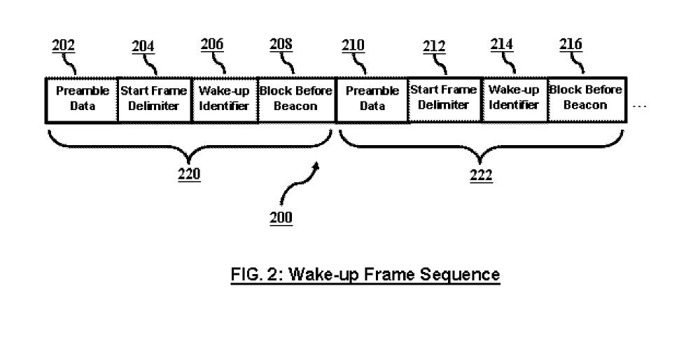

FIG. 2 illustrates the wake-up frame (WF) 220, 222 and its sequence 200. A wake-up frame consists of preamble data (PD), start frame delimiter (SFD), wake-up identifier (WI) and block before beacon (BBB). Sequence of wake-up frames 220, 222, will be transmitted by any network element i.e. PC or NC interested in network formation for unassociated dormant devices. Any node becomes dormant in two cases i) as soon as it is powered ON, or ii) if the network element happen to miss the synchronization information for consecutive preconfigured number of times. On reception of WF, the unassociated dormant devices synchronizes itself with WF sequence transmitting network element using preamble data 202, 210 and start frame delimiter 204, 212 and then decode the wake-up identifier 206, 214 and block before beacon 208, 216. The BBB contains the number of WF transmission before the start of beacon zone. The wake-up frame identifier is a predefined bit sequence to indicate the transmitting frame is a wake-up frame. On receiving the WF the unassociated device changes its mode from dormant mode to reception mode at appropriate time based on BBB value. In said next reception, the unassociated device listens to beacon frame and starts its association procedure. The wake-up frame sequence is transmitted by any network element after its network association and based on information received from its parent network element. As per existing standards PC transmits Beacon frame to start the network formation but in this proposed algorithm, PC transmits the WF sequence for pre-configured duration to start the network formation. Further network formation for plurality of layers network, at higher layers NC transmits the WF sequence based on information provided by its parent network element. The duration of wake-up frame sequence is dependent on the periodicity of dormant device reception attempt (P_{RX}) and configurable number of times (N_{Rx}) the dormant device is configured to get opportunities to listen to wake-up frame in a wake-up frame sequence transmission. Hence the duration of wake-up frame is product of the periodicity of dormant device reception attempt (P_{RX}) and configurable number of times (N_{Rx}) the dormant device is configured to get opportunities to listen to WF i.e. N_{Rx}*P_{RX}.

Transmission of wake-up frame can also be configured to transmit preconfigured number of times to be sure that all the near-by devices has listened the wake-up frame and starts their association procedure. In an existing network to support joining of new node, PC requests the required network coordinator to transmit WF sequence for configurable duration.

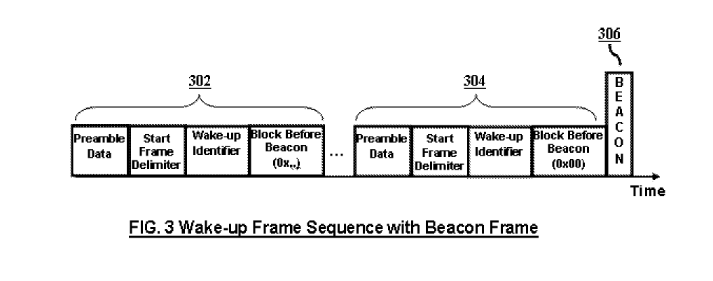

FIG. 3 illustrates transmission of beacon frame after wake-up frame sequence. As part of this invention, the beacon frame transmitted after the wake-up frame sequence requests the unassociated devices to transmit its identity frame (IF). As mentioned, the unassociated device decodes WF and become active in reception mode at proper time to listen to beacon frame and start its association procedure.

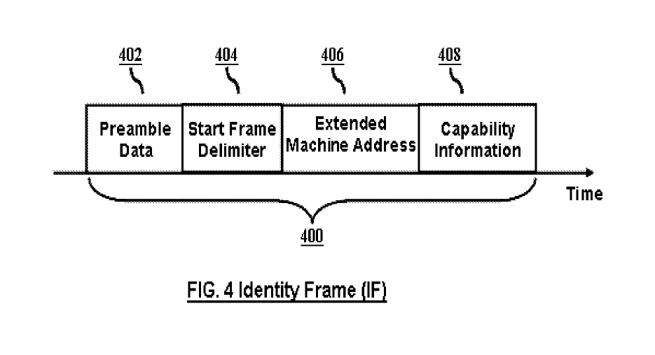

FIG. 4, illustrates an identity frame (IF). As part of this invention, we are introducing a new frame called as identity frame (IF), which is transmitted by any device on receiving the request to transmit its identity frame; it can receive the request either from its parent node when the device is associated with the network or from neighboring coordinator nodes when the device is not associated with any network. Identity frame consists of preamble data (PD) 402, start frame delimiter (SFD) 404, its extended machine address 406 and its capability information 408. All the devices contend to transmit its IF in the active period followed by the beacon frame. The contention to transmit the IF in active period can be done in two ways: 1) using carrier sense access scheme (CSAS), in this method the device keeps its transceiver active continuously in reception mode during the active period to listen to the identity frame transmitted by other nodes and also it keeps sensing the frequency channel using carrier sense multiple access with collision avoidance (CSMA-CA) access technique to find when the channel is free to transmit its identity frame for preconfigured number of times P_{Rx}; or 2) using time division access scheme (TDAS), in this method coordinator nodes dividing the active period into plurality of time slots N_{TS} sufficient enough to hold a IF and inform the count of such time slots in its beacon frame; nodes requested to transmit IF, generates a random number within the count provided by the coordinator and transmits the IF in that time slot. To increase the chance of coordinator node listening the IF without noise from all its neighboring nodes, the IF transmitter node can be configured to transmits the IF for configurable number of times R_{Tx}. In this case the configurable numbers of random numbers R_{Tx} are generated within the count N_{TS} provided by the coordinator and IFs are transmitted in that particular time slots. As per the proposed algorithm, during association procedure devices which are not transmitting the IF, are active in receive mode to listen to other's IF and build a table consisting the information contained in IF, the link quality indication (LQI), energy level (EL) and approximate distance for all the IF received from the neighboring nodes. The LQI and EL helps in estimating the channel conditions and approximate distance from its neighbor. This neighbor information is transmitted by the device to the coordinator in the association request so that the coordinator calculates its relative location with respect to other nodes and take its decision based on it at the time of association. Neighbor's information helps the coordinator node in assigning the unassociated full function device as coordinator at each depth of the network optimally and in localization activity.

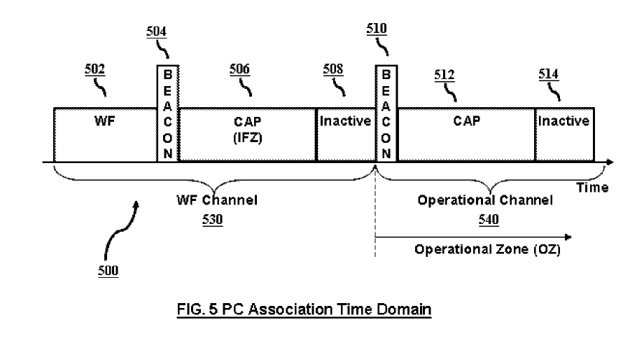

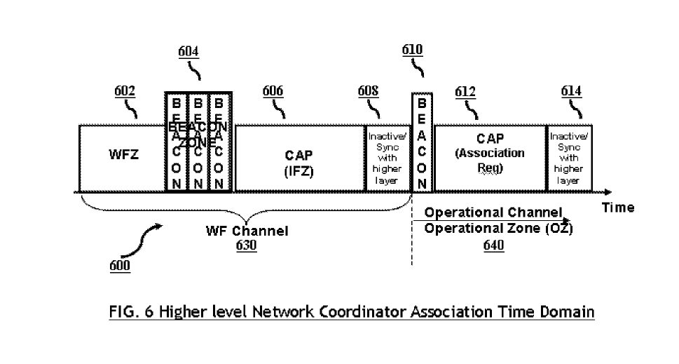

As we understand that in a cluster tree network topology, except at PC level, each level will have plurality of coordinator devices working in close proximity. If all the coordinator devices are allocated separate time to follow all the above procedure, it will delay the network formation. To make the association procedure efficient and fast, as part of this invention, the time domain is divided into different zones as illustrated in FIG. 5 and FIG. 6, which includes: i) wake-up frame zone (WFZ) 502, 602, ii) beacon zone (BZ), 504, 604, iii) identity frame zone (IFZ) 506, 606 and iv) operational zone (OZ) 540, 640. In wake-up frame zone (WFZ) all the nearby coordinator devices transmit the WF simultaneously. Since the WF does not contain any transmitter specific information it is possible for the synchronized nearby coordinator devices to transmit the WF frame at the same time on same channel. Simultaneous transmission of WF has plurality of advantages which includes the coordinators will have to transmit at lesser power to cover its transmission range and also it reduces the time required in network formation by many folds. Simultaneous transmission of WF from plurality of coordinators can also create noise if the transmitting coordinators are not synchronized within permissible accuracy or if they are distant enough to cause phase lag sufficient enough to add the WFs transmitted from different coordinators destructively i.e. when the phase difference of WFs transmitted from different coordinators is greater than one-forth of its wavelength. To overcome such condition, the neighboring coordinators are assigned different time zones. Coordinator starts its association procedure in its respective time zone. The delay between the consecutive time zones is sufficient enough for the coordinator node to complete the WF channel operation and then move to its operational channel.

Beacon zone (BZ) follows the wake-up frame zone, where all the neighboring coordinators transmit its beacon frame one after another with the time gap of inter-frame spacing (IFS). It is parent node's responsibility to group child layer coordinators into same time zones and allocate specific time slot of beacon zone to each coordinator. Since the beacon frame content is transmitter specific it is not transmitted simultaneously by plurality of coordinators. Each coordinator transmits its beacon frame in its respective BF time slot of BZ. The BZ is applicable till the coordinator nodes are operating in WF channel. The beacon frame transmitted in BZ 504, 604 contains its operational channel information and also requests to transmit identity frame. The next beacon transmission and further network operations happen on its operational channel. This approach is taken at each depth of the network, i.e. together coordinators of same time zone transmits the WF on WF channel, and then at their specified time slot it transmits its beacon frame on the same WF channel. After the beacon zone, next comes is the identity frame zone (IFZ) 506, 606, where all the unassociated nodes in the radio sphere of influence of coordinators transmitted its beacon in the beacon zone, transmit its IF. This method allows more neighboring nodes to transmit its IF in the same identity frame zone and hence the nodes will have better neighboring nodes information.

As mentioned earlier, based on network configuration the unassociated devices can transmits its IF in two different ways: 1) using carrier sense access scheme (CSAS) method in IFZ 506, 606 followed by the BZ; in this method the device keeps its transceiver active continuously in reception mode during the identity frame zone (IFZ) to listen to the identity frame transmitted by other nodes and also it keeps sensing the frequency channel using carrier sense multiple access with collision avoidance (CSMA-CA) access technique to find when the channel is free to transmit its identity frame for preconfigured number of times P_{Rx}; and 2) using time division access scheme (TDAS), in this method coordinator nodes of same beacon zone dividing the identity frame zone followed by beacon zone, into plurality of time slots N_{TS} sufficient enough to hold a IF and transmitting the count N_{TS} in its beacon frame; nodes requested to transmit IF, generates configurable number of random numbers R_{TS} within the count N_{TS} provided by the coordinator and transmits its IF in that time slots. Plurality of transmission of IF improves the chance of coordinator getting the IF without collision. During the identity frame zone, the nodes which are not transmitting the IF, are active in receive mode to listen to other's IF and build a neighbor table consisting the information contained in IF, the link quality indication (LQI), energy level (EL) and approximate distance for all the IF received from the neighboring nodes.

IFZ together for devices spread across large area has many advantages: i) the devices get the opportunity to listen to most of its possible neighbors, ii) better localization, and iii) less time required for network formation. As discussed earlier, each device generates a neighboring nodes information table after listening to neighbor's IF; by end of the IFZ each device have its neighboring table containing most of its neighboring nodes information. As suggested by standards the association request from the unassociated device is transmitted to a specific coordinator. To make this happen most efficiently, neighboring coordinators are allocated separate channel for its networking based on the location of coordinator and noise level in different channels. In this document, the new channel for networking operations is termed as Operational Channel and the initial channel where the WF was transmitted is termed as Wake-up Channel. Network coordinators tune to their operational channel after completion of inactive period 508, 608 followed by IFZ and transmits beacon frame 510, 610 requesting association requests to transmit. Active period following the beacon frame is contention access period (CAP) 512, 612 to transmit association requests. Similar to above case to transmit association request in CAP the network coordinator indicates in its beacon frame 510, 610 to choose either CSAS or TDAS. As per proposed algorithm network coordinators keep accumulating association requests for configured duration and then process the requests to find out most suitable child network coordinator and to associate other nodes as child end device. To find the operational channel for child network coordinator, current coordinator scans all the frequency channels mentioned in the network frequency channel preference list for configuration duration at the estimated time when the coordinator node is expected to become active periodically in the time domain to estimate the noise level in all the channels based on received signal strength indicator (RSSI) and then selecting required number of frequency channels which is having minimum noise level.

FIG. 5 and FIG. 6 shows the time domain of personal area network coordinator and higher level coordinators respectively at the time of association procedure. As shown in FIG. 5, at personal area network coordinator (PC) level PC will be the only entity which initiates the network formation, so the beacon zone 504 is just sufficient to hold one Beacon frame, where as FIG. 6 shows the time domain of higher level network coordinators where plurality of coordinators are in proximity and transmits beacon frame in same beacon zone hence the beacon zone 604 is divided into plurality of time slots. To make sure that no two coordinators transmit the beacon frame simultaneously, each coordinator is notified about its slot in beacon zone by its parent coordinator. The BZ has configurable number of time slots for beacon. Depending upon the neighboring coordinator devices, the parent coordinator configures the number of time slots in BZ and allocates the time slots to its child coordinators. Coordinator's synchronization with its higher layer happens in the inactive period of its child.

This proposed algorithm helps in building large networks fast and in efficient manner than existing algorithms.

What is claimed is:

1. A method for associating an unassociated wireless devices in a wireless communication network by associated coordinator node, comprising steps of:
creating wake-up frame sequence, which is repetition of wake-up frames based on configurable parameters i.e. configurable duration (T_{mixRx}) for which unassociated dormant device attempts to listen to said wake-up frame sequence in each of its reception attempt, said unassociated dormant device's listening periodicity (P_{Rx}) and number of opportunities (N_{Rx}) said unassociated dormant device gets to listen to wake-up frame;
transmitting said wake-up frame sequence on preconfigured wake-up frame frequency channel at wake-up frame zone specified by its parent;
creating beacon frame comprising request to transmit identity frame, identity frame zone information, its operational frequency channel information and synchronization information;
transmitting said beacon frame on said wake-up frame channel, at the specific time slot of beacon zone specified by its parent;
listening to said wake-up frame frequency channel for identity frames and building neighbor table based on received identity frames content and its signal strength;
transmitting beacon frame on said operational frequency channel, indicating that it is ready for association using association permit field of beacon frame;
listening to said operational frequency channel for association requests and accumulating it;
processing neighbor table information, said accumulated association requests and logical address availability for child end device and child network coordinators to calculate logical addresses for the unassociated devices; and
allocating logical address to unassociated devices obtained after said processing of neighbor table information, said accumulated association requests and logical address availability for child end device and child network coordinators;
whereby association procedure happens in time and power efficient manner and it also enables to build elaborate neighbor table which helps in allocating logical address in efficient manner and improvises localization procedure.

2. The method, as claimed in claim 1, wherein said wake-up frame (WF) is a data sequence to request dormant mode devices to start its association procedure and is comprising of:
preamble data (PD) for frequency synchronization;
start frame delimiter (SFD) for time synchronization;
wake-up frame identifier (WFI) to indicate that the current frame is wake-up frame; and
block before beacon (BBB) to indicate the number of wake-up frame transmissions before start of beacon zone.

3. The method, as claimed in claim 1, wherein said wake-up frame zone is a time period in which either a wake-up frame is transmitted by wireless personal area network controller (PC) at the time of start of network formation or wake-up frames are transmitted by network coordinators of said wireless communication network on triggering by its parent node, where said parent node based on its peer node and child node's information divides the time in different time zones to provide specific time zone to its child network coordinators in such a way that simultaneous transmission of wake-up frame from plurality of said child network coordinators are possible without interference.

4. The method, as claimed in claim 1, wherein said wake-up frame sequence duration is designed to provide configurable number of opportunities (N_{Rx}) for dormant nodes to listen to wake-up frame for its any configurable listening periodicity (P_{Rx}) which will be equal to the product of said configurable number of opportunities (N_{Rx}) and said configurable listening periodicity (P_{Rx}) i.e. N_{Rx}*P_{Rx};

5. The method, as claimed in claim 1, wherein said beacon zone is a time period having plurality of time slots each sufficient enough to hold a beacon frame, as specified by parent node said network coordinator transmits its beacon frame in its specified time slot.

6. The method, as claimed in claim 1, wherein said operational frequency channel information of any coordinator node is informed by its parent node after said parent node scanning all the channels provided in channel preference list at estimated time when said coordinator node is expected to be active periodically in the time domain for configurable duration to estimate the noise level in said channels based on received signal strength indicator (RSSI) and then selecting required number of said frequency channels having minimum said noise level.

7. The method, as claimed in claim 1, wherein said identity frame is transmitted by any node whether it is associated or unassociated with said wireless communication network on reception of request to transmit identity frame, it is to indicate its identity and capability.

8. The method, as claimed in claim 1, wherein said identity frame is a data sequence comprising of:
preamble data (PD) for frequency synchronization;
start frame delimiter (SFD) for time synchronization;
extended machine address (EMA) for device identity and its machine address information; and
capability information (CI) to inform about its capability i.e. said device is a full function device or reduced function device, about its battery level and about its microprocessor and transceiver capability.

9. A method for associating to a wireless communication network by an unassociated device, comprising steps of:
listening to wake-up frame channel for said configurable duration (T_{mixRx}) at said configurable periodicity (P_{RX});
decoding said wake-up frame on its successful reception and based on said wake-up frame content indicating the relative time at which beacon zone starts and its hardware capability, changing its mode to low power consumption mode till start of said beacon zone, otherwise on unsuccessful reception of wake-up frame said unassociated device continuing in dormant mode;
activating transceiver in reception mode tuned to listen to said wake-up frame frequency channel at said start of beacon zone;
listening to all the beacon frames transmitted in said beacon zone and based on received signal strength calculating the approximate distance and estimating the frequency channel quality of all the said beacon frame transmitting coordinators;
creating an identity frame on receiving said beacon frame comprising request to transmit identity frame;
transmitting said identity frame in beacon frame specified identity frame zone (IFZ) using transmission method specified in said beacon frame content i.e. either by using carrier sense access scheme (CSAS) method or by using time division access scheme (TDAS) method;
listening to said wake-up frame frequency channel, in said identity frame zone (IFZ) when not transmitting its own said identity frame to listen to neighboring node's identity frames;
building neighbor table based on received identity frames from neighboring nodes;
finding out most suitable coordinator to associate with based on network policy, said signal strength, link quality and association permit value of received beacon frames from neighboring coordinators wherein network policy can be to choose the coordinator whose frequency channel is estimated best based on said signal strength and link quality values;
tuning transceiver frequency to operational channel of chosen coordinator and listening to said coordinator's beacon frame;
creating and transmitting association request on said operational channel of chosen coordinator; and
listening to association response from said coordinator;
whereby unassociated device helping coordinator to build extended neighbor table before allowing unassociated devices to associate with it and hence helping said coordinator node to use its available logical addresses efficiently, minimizing the chance of holes in region intended to cover through the network and associating the unassociated device.

10. The method, as claimed in claim 9, wherein said carrier sense access scheme (CSAS) method comprising steps of:
keeping transceiver active in reception mode by wireless device in identity frame zone to listen to neighboring node's identity frames and transmitting its identity frame whenever frequency channel is identified free using carrier sense multiple access with collision avoidance (CSMA-CA) access technique;
whereby identity frames are transmitted by plurality of neighboring nodes in same identity frame zone and also listened to neighboring node's identity frames.

11. The method, as claimed in claim 9, wherein said time division access scheme (TDAS) method comprising steps of:
splitting the identity frame zone into plurality of time slots (N_{TS}) sufficient enough to transmit an identity frame by coordinator node transmitting its beacon frame;
transmitting said number of time slots N_{TS} of identity frame zone by said coordinator node in its beacon frame;
generating configurable number of random numbers (R_{Tx}) within said number of time slots (N_{TS}) by beacon frame receiving node on reception of said beacon frame; and
transmitting identity frame at said random time slots by said beacon frame receiving node and on other time slots keeping its transceiver in active reception mode to listen to neighboring node's identity frames;
whereby identity frames are transmitted by plurality of neighboring nodes in same identity frame zone and also listened to neighboring node's identity frames.

12. The method, as claimed in claim 9, wherein said association permit value is a content of beacon frame indicating whether association is allowed or not with the coordinator transmitting said beacon frame.

13. The method, as claimed in claim 9, wherein said association request comprising physical layer header, medium access control (MAC) header, command identifier indicating association request, capability information and said neighbor table information;

14. A system for networking a wireless communication device having networking capabilities with a wireless communication network as claimed in claim 1 comprising, a full function device personal area network controller (PC), a full function device network coordinator (NC) and a reduced function device end device (ED).

15. The system according to claim 14, wherein said full function device is a wireless networking device capable of networking with reduced function device or other full function device and it is capable to operate in three modes serving as personal area network controller (PC), a network coordinator (RN) or as a end device (ED).

16. The system according to claim 14, wherein said reduced function device is a wireless networking device capable of networking with only full function device and it can serve as leaf node (LN) in any network.

17. The system according to claim 14, wherein said full function device comprising:
means for creating wake-up frame sequence, which is repetition of wake-up frames based on configurable parameters i.e. configurable duration (T_{mixRx}) for which unassociated dormant device attempts to listen to said wake-up frame sequence in each of its reception attempt, said unassociated dormant device's listening periodicity (P_{Rx}) and number of opportunities (N_{Rx}) said unassociated dormant device gets to listen to wake-up frame;
means for transmitting said wake-up frame sequence on preconfigured wake-up frame frequency channel at wake-up frame zone specified by its parent;
means for creating beacon frame comprising request to transmit identity frame, identity frame zone information, its operational frequency channel information and synchronization information;
means for transmitting said beacon frame on said wake-up frame channel, at the specific time slot of beacon zone specified by its parent;
means for listening to said wake-up frame frequency channel for identity frames and building neighbor table based on received identity frames content and its signal strength;
means for transmitting beacon frame on said operational frequency channel, indicating that it is ready for association using association permit field of beacon frame;
means for listening to said operational frequency channel for association requests and accumulating it;
means for processing neighbor table information, said accumulated association requests and logical address availability for child end device and child network coordinators to calculate logical addresses for the unassociated devices; and
means for allocating logical address to unassociated devices obtained after said processing of neighbor table information, said accumulated association requests and logical address availability for child end device and child network coordinators;

18. The system according to claim 14, wherein said full function device and reduced function device comprising:
means for listening to wake-up frame channel for said configurable duration (T_{mixRx}) at said configurable periodicity (P_{RX});
means for decoding said wake-up frame on its successful reception and based on said wake-up frame content indicating the relative time at which beacon zone starts and its hardware capability, changing its mode to low power consumption mode till start of said beacon zone, otherwise on unsuccessful reception of wake-up frame said unassociated device continuing in dormant mode;
means for activating transceiver in reception mode tuned to listen to said wake-up frame frequency channel at said start of beacon zone;
means for listening to all the beacon frames transmitted in said beacon zone and based on received signal strength calculating the approximate distance and estimating the frequency channel quality of all the said beacon frame transmitting coordinators;
means for creating an identity frame on receiving said beacon frame comprising request to transmit identity frame;
means for transmitting said identity frame in beacon frame specified identity frame zone (IFZ) using transmission method specified in said beacon frame content i.e. either by using carrier sense access scheme (CSAS) method or by using time division access scheme (TDAS) method;
means for listening to said wake-up frame frequency channel, in said identity frame zone (IFZ) when not transmitting its own said identity frame to listen to neighboring node's identity frames;
means for building neighbor table based on received identity frames from neighboring nodes;
means for finding out most suitable coordinator to associate with based on network policy, said signal strength, link quality and association permit value of received beacon frames from neighboring coordinators wherein network policy can be to choose the coordinator whose frequency channel is estimated best based on said signal strength and link quality values;
means for tuning transceiver frequency to operational channel of chosen coordinator and listening to said coordinator's beacon frame;
means for creating and transmitting association request on said operational channel of chosen coordinator; and
means for listening to association response from said coordinator;
